(19) United States
(12) Patent Application Publication
(10) Pub. No.: US 2016/0274564 A1
(43) Pub. Date: Sep. 22, 2016

(54) GANTRY ROBOT SYSTEM WITH EXTENSION BRIDGE

(71) Applicant: Jeffrey R. Schultz, Dayton, OH (US)

(72) Inventor: Jeffrey R. Schultz, Dayton, OH (US)

(73) Assignee: Production Design Services, Inc., West Carrollton, OH (US)

(21) Appl. No.: 14/879,520

(22) Filed: Oct. 9, 2015

Related U.S. Application Data
(63) Continuation-in-part of application No. 14/663,051, filed on Mar. 19, 2015.

(51) Int. Cl. G05B 19/31; G05B 15/02

(52) U.S. Cl. CPC G05B 19/31; G05B 15/02; Y10S 901/14; G05B 2219/31305

(57) ABSTRACT

A gantry robot system may include a gantry; a slide movably mounted on the gantry; an articulated arm mounted on the slide for performing a machining operation; a first workstation having a workpiece feeder for moving a first workpiece through the gantry; a second workstation adjacent the gantry for supporting a second workpiece; and a computer control connected to actuate the slide, the articulated arm, and the workpiece feeder in a coordinated manner to perform a first preselected machining operation on the first workpiece at the first workstation, and a second preselected machining operation on the second workpiece at the second workstation.

### FIELD

This disclosure relates to robot systems, and more particularly, to robot systems in which a robot arm is mounted on a gantry to perform a machining operation.

### BACKGROUND

Manufacturing operations are becoming increasingly automated. A significant factor in increasing such automation is the use of robots to perform repetitive tasks that require multiple, high-precision movements. Another factor favoring the use of robots is that a robot can perform a machining task in an environment, or using tools, that may present hazards to humans. For example, a robot may be used to perform a machining operation that utilizes a plasma torch to cut metal such as steel. The use of a plasma torch generates extremely high temperatures, electric arcs, noxious gases, and a spray of molten metal.

There are several forms of robot devices that may be used to perform machining tasks. In one form, a machining tool, such as a plasma torch, an arc welder, or other device, may be mounted on an end of a machining tool that is moved by rails oriented at right angles to each other to move the machining tool in an X-Y direction, so that the machining operation follows a pattern in the form of Cartesian coordinates. An advantage of such a system is that it is relatively inexpensive, and can be repaired relatively quickly.

A robot also may take the form of a robotic arm. Such robotic arms may be computer controlled and include an end effector, which may be a plasma torch, connected to a swivel base by articulated segments. The swivel base and articulated segments give the robot arm flexible movement in three dimensions. However, such robotic arms are limited in reach to the collective length of the articulated arm segments. Such articulated robotic arms may be mounted on a gantry so that the robot arm itself may be displaced along the gantry rail to provide added reach. The size of a workpiece that may be operated on may be limited by the size of the gantry and the reach of the robotic arm.

Accordingly, there is a need for a gantry robot system that provides maximum flexibility of positioning of the end effector of the robot arm, and can accommodate a wide range of workpiece sizes within a minimal footprint.

### SUMMARY

The present disclosure is a gantry robot system that, in various aspects, provides flexibility in positioning the end effector of the robot arm, and accommodates a wide range of workpiece sizes and widths within a minimal footprint. In one aspect, a gantry robot system includes a gantry; a slide movably mounted on the gantry; an articulated arm mounted on the slide for performing a machining operation; a first workstation having a workpiece feeder for moving a first workpiece through the gantry; a second workstation adjacent the gantry for supporting a second workpiece; and a computer control connected to actuate the slide, the articulated arm, and the workpiece feeder in a coordinated manner to perform a first preselected machining operation on the first workpiece at the first workstation, and a second preselected machining operation on the second workpiece at the second workstation.

In another aspect, a gantry robot system includes a gantry having a linear rail; a first workstation having a workpiece feeder for moving a first workpiece beneath the linear rail; a second workstation adjacent the linear rail having a first worktable for supporting a second workpiece, and a second worktable for supporting a third workpiece, the linear rail extending between the first work table and the second worktable; a slide mounted on the linear rail and movable to the first workstation and to the second workstation; an articulated arm mounted on the slide for performing a machining operation; and a computer control connected to actuate the slide, the articulated arm, and the workpiece feeder in a coordinated manner to perform a first preselected machining operation on the first workpiece at the first workstation, a second preselected machining operation on the second workpiece at the second workstation, and a third preselected machining operation on the third workpiece at the second workstation.

In yet another aspect, a method for making a gantry robot system includes assembling a gantry having a linear rail, and first, second, and third upright supports connected to and supporting the linear rail; attaching a slide to the gantry that is movable along the linear rail; mounting an articulated arm on the slide that is adapted to receive an end effector for performing a machining operation; attaching a first workstation to the gantry, the first workstation having a workpiece feeder for moving a first workpiece beneath the linear rail; providing a second workstation adjacent a portion of the linear rail extending beyond the first workstation, the second workstation including a work table for supporting a second workpiece shaped to be positioned adjacent the linear rail; and connecting a computer control to the slide, the articulated arm, and the workpiece feeder, and programming the computer control to actuate the slide, and the articulated arm, and the workpiece feeder in a coordinated manner to perform a first preselected machining operation on the first workpiece at the first workstation, and a second preselected machining operation on the second workpiece at the second workstation.

Other objects and advantages of the disclosed robot gantry system will be apparent from the following description, the accompanying drawings, and the appended claims.

### BRIEF DESCRIPTION OF THE DRAWINGS

FIG. 1 is a somewhat schematic, front elevational view of one aspect of the disclosed gantry robot system;

FIG. 2 is a detail of the gantry robot system of FIG. 1, showing the relative spatial orientation of the powered roller, the guide roller, and the clamping roller;

FIG. 3 is a schematic, side elevation showing a position of the robot arm and end effector relative to a workpiece passing beneath the gantry;

FIG. 4 is a schematic front elevational view of the gantry robot system of FIG. 1, showing movement of the slide relative to the gantry and different positions of the robot arm;

FIG. 5 is a schematic of the computer control system of the gantry robot system of FIG. 1;

FIG. 6 is a flow chart of the operation of the computer control of the gantry robot system of FIG. 1;

FIG. 7 is a schematic, perspective view of another aspect of the disclosed gantry robot system; and

FIG. 8 is a schematic, perspective view of the aspect of FIG. 7, with the articulated arm positioned at a different work station.

### DETAILED DESCRIPTION

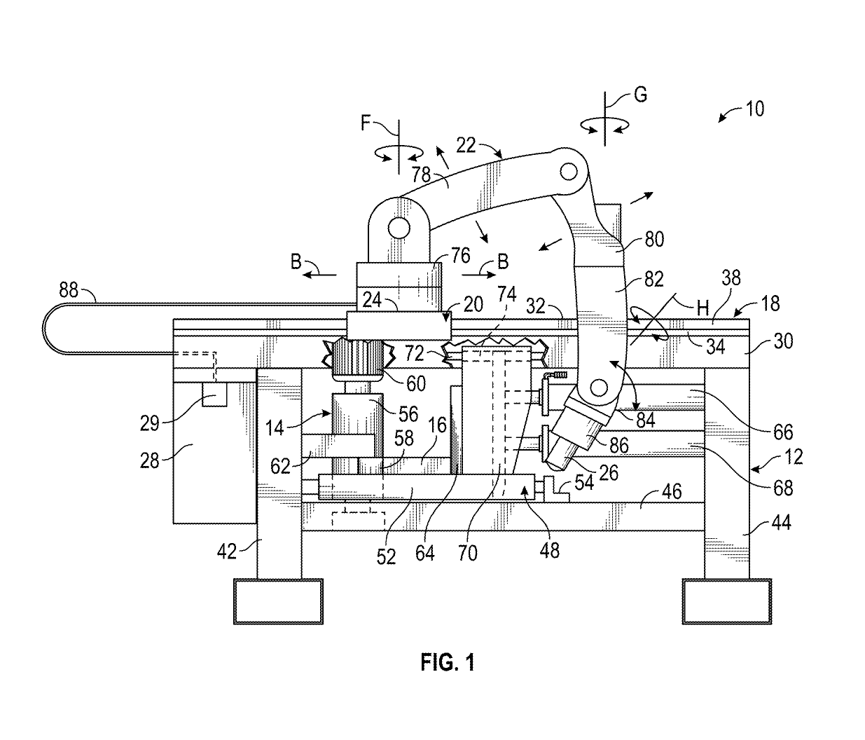

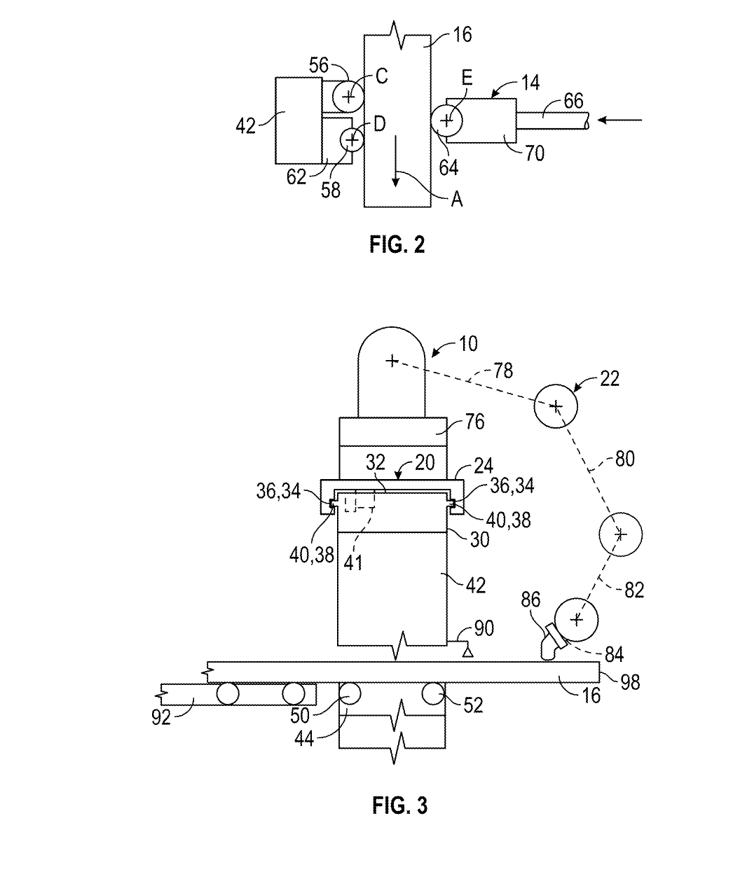

As shown in FIG. 1, the disclosed robot gantry system, generally designated 10, may include a workpiece support, generally designated 12, a workpiece feeder, generally designated 14, for engaging a workpiece 16, which may take the form of a flat plate, and for moving the workpiece in a first direction, indicated by arrow A (see FIG. 2) relative to the workpiece support. The system 10 may also include a gantry, generally designated 18, and a slide 20 moveably mounted on the gantry and moveable in a second direction, indicated by arrows B different from the direction of movement of the workpiece by the workpiece feeder 14.

An articulated arm, which in an embodiment may take the form of an articulated robot arm, generally designated 22, may be mounted on an upper surface 24 of the slide 20 and may have an end effector 26 at an end of the articulated arm opposite the slide 20. In robotics, an end effector is a device at the end of a robot arm designed to interact with the environment. The exact nature of the end effector depends on the application of the robot. In embodiments, the end effector 26 may be selected from a plasma torch, an arc welder, an abrasive grinder, an adhesive applicator, a seal dispenser, a drill, and a stylus for marking or scribing, among other tools. Applicable plasma cutting systems may include Hypertherm HyDefinition Plasma Cutting Systems models HPR800XD, HPR400HD, HPR260XD, HPR130XD; Hypertherm Air and O₂ plasma cutting system models MaxPro 200 and HSD130; and Thermal-Dynamics high precision plasma cutting system model Ultra-Cut XT systems from 100-400 amps output.

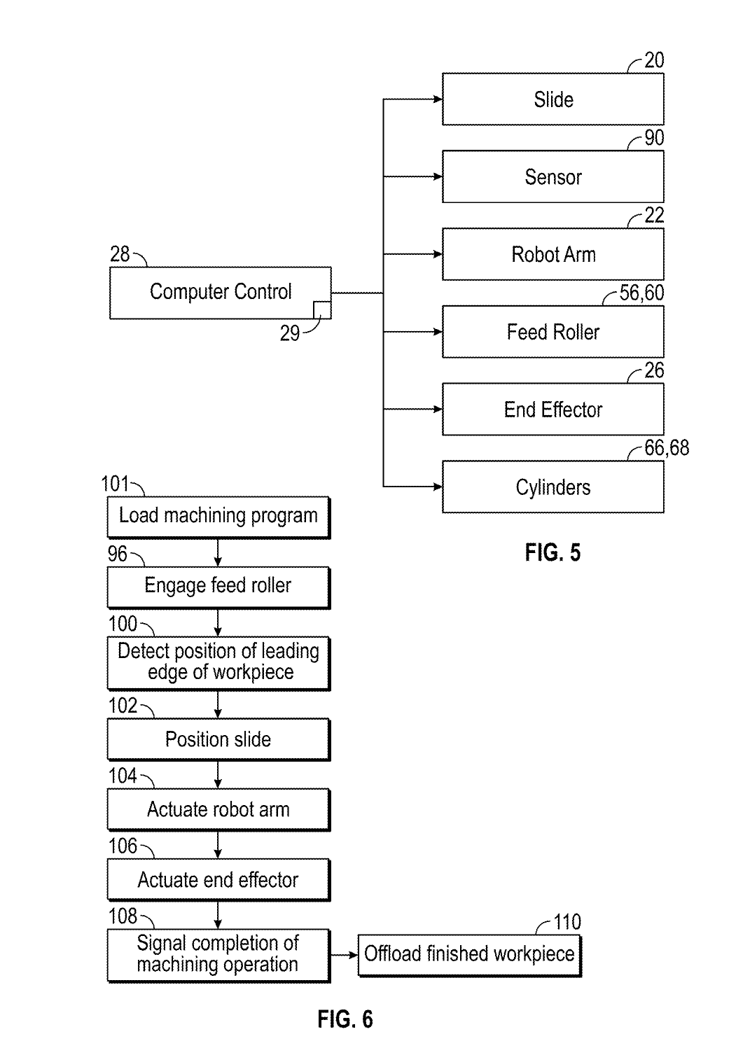

The system 10 also may include a computer control 28 (see also FIG. 5), which in embodiments may include, or communicate with, or communicate with other components of the system 10 through, a programmable logic controller (PLC) component 29, as shown schematically in FIG. 5, and as will be described. The computer control 28 may be connected to actuate the workpiece feeder 14, the slide 20, the articulated arm 22 and the end effector 26 in a coordinated manner to perform a preselected machining operation.

In an embodiment, the gantry 18 may be positioned above the workpiece support 12, and may include a linear rail 30. The slide 20 may be mounted on the rail 30 to slide along the top surface 32 of the rail. As shown in FIGS. 1 and 2, the slide 20 may include opposing, inwardly facing slots 34, 36 shaped to receive and engage opposing, longitudinal ribs 38, 40, respectively, extending outwardly from opposing vertical side walls forming the linear rail 30. In an embodiment, the slide 20 is supported on, and slides along, the ribs 38, 40 to provide clearance above the top surface 32 of the rail. The slide 20 may be moved in the direction of arrows B (FIG. 1) by a rack and pinion 41 internal to the rail 30 (FIG. 2). In an embodiment, the linear rail 30 may be oriented substantially perpendicular to the direction of travel of the workpiece 16 indicated by arrow A in FIG. 2. With such an orientation, the slide 20 may be moveable in the direction indicated by arrows B that is substantially perpendicular to the feed direction indicated by arrow A.

As shown in FIG. 1, the workpiece support 12 may include first and second upright supports 42, 44, a lower transverse brace 46 that extends between and is attached to the upright supports, and a roller support, generally designated 48, for the workpiece 16 that extends substantially horizontally. The linear rail 30 of the gantry 18 may be mounted on and supported by the first and second upright supports 42, 44, so that the linear rail adds stiffness to, and may form a structural component of, the workpiece support 12.

In an embodiment, the workpiece roller support 48 may include rollers 50, 52 (see FIG. 3) that may be rotatably mounted on the upright 42 at one end, and an L-bracket 54 the rotatably receives the rollers at an opposite end. The L-bracket 54 may be mounted on the lower transverse brace 46. The workpiece feeder 14 may include at least one powered roller 56 and a guide roller 58. The powered roller 56 may be rotatably mounted to the workpiece support 12, and in embodiments mounted on the first upright support 42. The powered roller 56 may driven by a motor 60 that is mounted on the linear beam 30 of the gantry 18, and is powered and actuated by the computer control 28.

In embodiments, the motor 60 may take the form of a servo motor, such as an electric servo motor. As shown in FIG. 2, the powered roller 56 and the guide roller 58 may be aligned relative to each other to guide the workpiece 16 in the feed direction indicated by arrow A. In embodiments, the workpiece feeder 14 may include more than one powered roller (not shown). The guide roller 58 may be rotatably mounted on a bracket 62 that in turn is attached to the first upright support 42 of the workpiece support 14 (see FIG. 2).

In an embodiment, the workpiece feeder 14 of the gantry robot system 10 may include a clamping roller 64 for urging the workpiece 16 against the powered roller 56 and the guide roller 58 (see FIGS. 1 and 2). The computer control 28 may be configured to actuate the clamping roller 64 through the PLC component 29 selectively to urge the workpiece 16 sidewardly against the powered roller 56 and the guide roller 58 and conversely, to release the workpiece from engagement with the powered roller and the guide roller. The clamping roller 64 may be displaced by cylinders 66, 68, which may take the form of double-acting hydraulic cylinders or double-acting pneumatic cylinders, each of which may be actuated by the PLC component 29 of the computer control 28. As shown in FIG. 1, the cylinders 66, 68 may be oriented such that cylinder 66 is an upper cylinder and cylinder 68 is a lower cylinder. The attachment of the cylinders 66, 68 to the second upright support 44 may be a pivotable attachment, or may be fixed, as by bolting directly to the second upright support.

The workpiece feeder 14 may include a clamping roller retainer 70 that is slidably mounted on the linear rail 30 of the gantry 18. In an embodiment, the linear rail 30 may include parallel, opposing grooves 72, extending longitudinally and formed on opposing inner surfaces thereof, that may receive and retain parallel, opposing longitudinal ribs 74 protruding from an upper end of the clamping roller retainer 70. The clamping roller 64 may be rotatably mounted on the clamping roller retainer 70 and the cylinders 66, 68 attached to a side of the clamping roller retainer 70 opposite the clamping roller 64. Accordingly, when the cylinders 66, 68 are actuated by the computer control 28, the clamping roller retainer 70 may be displaced linearly along the linear rail 30 of the gantry 18 beneath the slide 20 toward and away from the workpiece 16, the powered roller 56, and the guide roller 58.

As shown in FIGS. 1 and 2, the powered roller 56, the guide roller 58, and the clamping roller 64 rotate about substantially vertical axes C, D, and E, respectively. The substantially vertical axes C, D, and E are substantially parallel to each other, and substantially perpendicular to the workpiece feed direction indicated by arrow A. As shown in FIG. 2, the rotational axis E of the clamping roller 64 is offset from (i.e., is not on a line perpendicular to arrow A with) the rotational axis C of the powered roller 56, and is offset from the rotational axis D of the guide roller 58. Consequently, the clamping roller 64 may urge the workpiece 16 sidewardly against both the powered roller 56 and the guide roller 58, thereby preventing the workpiece from skewing relative to the feed direction indicated by arrow A.

As shown in FIG. 1, the robot arm 22 may include a swivel base 76 rotatably mounted on the upper surface 24 of the slide 20 to rotate about a vertical axis F, a lower arm 78 pivotally attached to the swivel base, an upper arm 80 pivotally attached to the lower arm, and arm roll 82 rotatably attached to the upper arm to rotate about an axis G, and a wrist bend 84 rotatably attached to the arm roll to rotate about an axis H, and a tool flange 86 pivotally and rotatably attached to the arm roll. Accordingly, the robot arm 22, the slide 20, and the workpiece feeder 14 collectively provide at least eight degrees of freedom to the end effector 26. Examples of such a robot arm 22 include Yaskawa Motoman Model MH24, Model HP20, and Model HP20R; Kawasaki Model RS10L, and Model RS15X; Fanuc ArcMate Models 120iC and 120iC-10L; KUKA Models KR16 and KR16L8; and ABB Model IRB2600 ID. The described embodiment utilizes a Yaskawa Motoman MH24 robot, the specifications of which are set forth in Yaskawa technical specification sheet DS-601-A published January 2015, the entire contents of which are incorporated herein by reference.

The slide 20 may include an energy chain connector 88 that carries power cables and, if necessary, gas and/or air and/or hydraulic lines to the robot arm 22 and end effector 26. The energy chain 88 may be attached to the computer control 28 which may be connected to sources of power, pressurized hydraulic fluid, and various gases (not shown) for performing machining operations. An available energy chain 88 is E4 Series, fully enclosed, by igus Inc. of Cologne, Germany.

As shown in FIG. 3, the system 10 may include a sensor 90 that may be mounted on an upright 42 (FIG. 1) and connected to the PLC component 29 of the computer control (see FIG. 5). The sensor 90 may be positioned to detect the position of the workpiece 16 as it leaves a feed conveyor, generally designated 92, upstream of the gantry robot system 10, and passes beneath the gantry 18 to a position where the predetermined machining operation is to occur. The sensor 90 also detects when the trailing edge leaves the workpiece roller support 48 of the system 10, so that the PLC component 29 may signal to the computer control 28 that the workpiece 16 is clear and to deactivate the predetermined machining process.

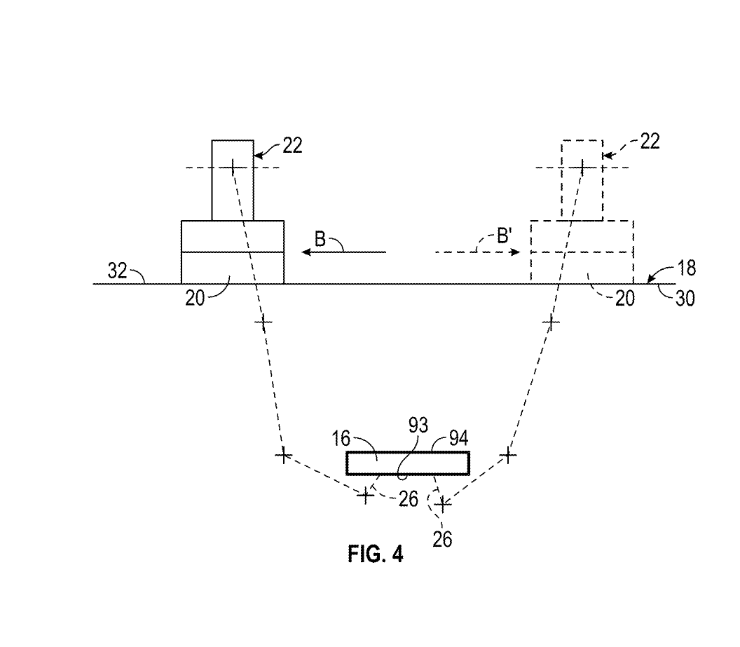

As shown in FIGS. 1 and 3, the robot arm 22 may be manipulated by the computer control 28 to perform a machining operation on the workpiece 16 at a variety of locations on the workpiece. The improved flexibility of the system 10 is shown best in FIG. 4. By displacing the slide 20 along the upper surface 32 of the linear rail 30 of the gantry 18, the robot arm 22 may be positioned to perform machining operations on an underside of the workpiece 16 without having to move the workpiece itself from its position shown in FIG. 1. Consequently, the workpiece 16 may remain stationary, or in applications will not have to be rotated or tilted about a longitudinal axis, or elevated or declined from a substantially horizontal orientation, while the robot arm 22 is displaced by the computer control 28 along the rail 30 to enable the end effector 26 to perform machining operations even on an underside or bottom surface 92 of the workpiece 16 without moving the workpiece from its position in which the robot arm positions the end effector to perform machining operations on the upper or top surface 94 of the workpiece.

For example, by moving the slide 20 in the direction of arrow B in FIG. 4, the robot arm 22 may be manipulated by the computer control 28 to reach an underside 93 of the workpiece 16; that is, to the left of the workpiece as shown in FIG. 4. Conversely, by movement of the slide 20 in the direction of arrow B′, the robot arm 22 may be positioned to reach an underside surface 93 of the workpiece 16 with the end effector 26 that is to the right of the workpiece, all without moving the spatial location of the workpiece 16 to perform either operation. Although gantry robots of this type typically may be used for overhead work processes, the disclosed gantry robot system 10 may be sufficiently flexible to perform machining operations on an underside surface 93 of a workpiece 16, without having to move the workpiece spatially relative to the system 10.

The operation of the gantry robot system 10 is described schematically in FIG. 6. As indicated at block 101, a set of commands for a preselected machining operation may be loaded into the computer control 28. Commands for the preselected machining operation may be selected from a table or library of machining operations stored in the computer control 28, or transmitted to the computer control over a wired or wireless network, or manually programmed, or loaded from a portable data storage device such as a thumb or zip drive. The computer control 28 may be programmed to perform a machining operation and may employ known software, such as StruCim, to create a cutting program from a supplied CAD file having the predetermined machining operation. Although shown prior to engaging the feed roller in block 96, the step of loading the machining program shown in block 101 may be performed or prior to detecting the position of the leading edge of the workpiece of block 100, or at another appropriate time in the sequence of steps of FIG. 6. Indeed, the program of block 101 may be pre-loaded in the computer control 28 prior to the system 10 receiving workpiece 16.

As shown in block 96, the workpiece 16, which may take the form of a flat plate of metal such as steel, may be offloaded from a feed conveyor 92 (see FIG. 3) until the plate engages the powered feed roller 56 (FIG. 1) and guide roller 58. The cylinders 66, 68 may be actuated by the computer control 28 to urge the clamping roller 64 against the feed roller 56 and guide roller 58, as shown in FIG. 1. The feed roller 56 then may be actuated by the computer control 28 to feed the workpiece 16 in the feed direction indicated by arrow A (see FIG. 2) until the leading edge 98 (see FIG. 3) of the workpiece is detected by the sensor 90, as indicated by block 100.

Next, the computer control 28 may actuate the slide 20 to a preselected position along the linear rail 30, such as the position shown in FIG. 1 or 4, or a position intermediate or different from the position shown in those figures for best positioning of the robot arm 22, as indicated in block 102 to perform, or to initiate, a preselected machining operation. The robot arm 22 may then be actuated by the computer control 28, as indicated in block 104, to position the end effector 26 to perform the preselected machining operation, which in an embodiment may include cutting with a plasma torch. As indicated in block 106, when the articulated arm 22 is positioned appropriately, then as indicated in block 106 the end effector 26 is actuated by the computer control 28 to perform the preselected machining operation.

The machining operation, which may be directed by commands from the program instructions loaded into the computer control 28, may cause the slide 20 to move along the linear rail 30, the robot arm 22 to swivel on the slide, and the arm to position the end effector 26 at a location, or at a series of locations on the workpiece 16, or to perform a machining operation, or a continuous machining operation, such as a continuous cut or series of cuts, on the workpiece. The commands loaded into the computer control 28 in block 101 also may cause the feed roller 56 of the workpiece feeder 14 to rotate alternately in a forward and a reverse direction, and/or a series of combinations of forward and reverse directions, and/or a series of forward directions, each of which may be of a different distance, simultaneously with movement of the robot arm 22, and/or slide 20, and/or end effector 26, to position the workpiece 16 at a predetermined location for the machining operation or operations. Thus, the computer control 28 actuates the feed roller 56 and workpiece feeder 14, the gantry 18 and slide 20, the robot arm 22, and the end effector 26 to act together in a coordinated manner to perform a preselected machining operation on a workpiece 16.

The computer control 28 may indicate the completion of the machining operation, as indicated in block 108, by an indicator light (not shown) and/or a tone or chime, whereupon the machined workpiece 16 may be offloaded, for example, by placing it on a downstream conveyor, table, or truck (not shown) adjacent the gantry robot system 10, indicated at block 110.

This disclosure also encompasses a method for making the gantry robot system 10. The method may include forming the workpiece support 12 having the workpiece feeder 14 for guiding the workpiece 16 a first direction relative to the workpiece support. The gantry 18 may be positioned above, and in embodiments mounted on, the workpiece support 12. The slide 20 may be mounted on the gantry 18 for movement along the top surface 32 thereof in a second direction substantially perpendicular to the first direction of the workpiece 16. An articulated robot arm 22 is mounted on the upper surface 24 of the slide 20 for rotational movement relative to the slide. The end effector 26 may be attached to the robot arm. And, a computer control 28 may be connected to actuate the workpiece feeder 14, the slide 20, the robot arm 22, and the end effector 26.

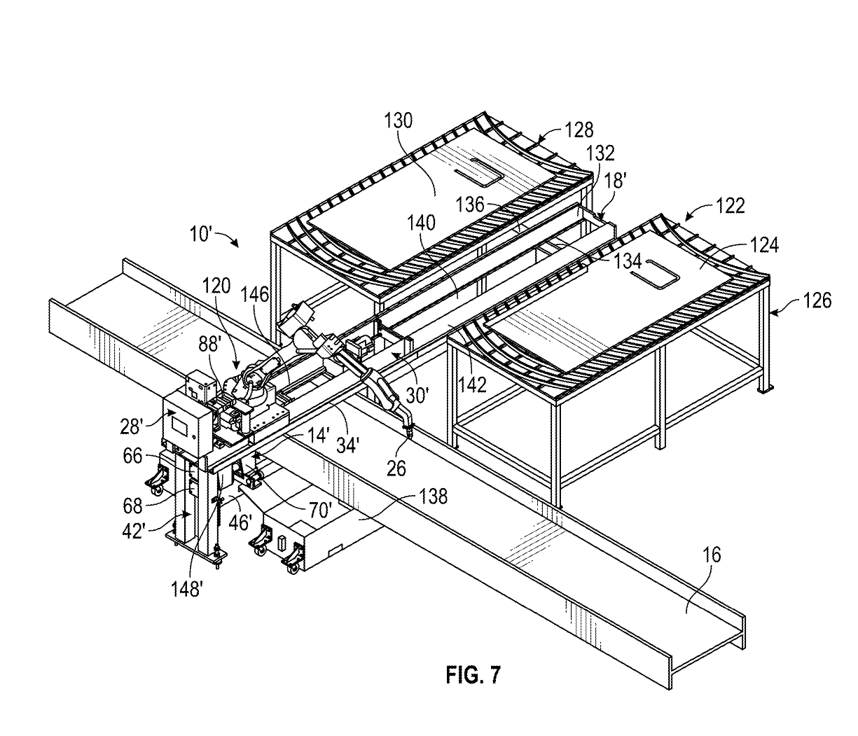

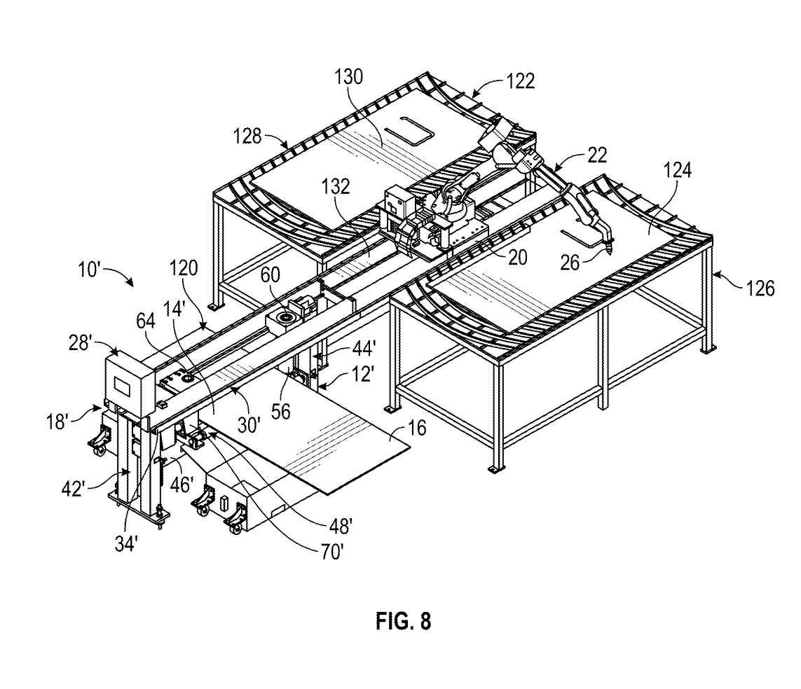

Another aspect of the disclosed gantry robot system 10′ is shown in FIGS. 7 and 8. The gantry robot system 10′ may include a gantry 18′, a slide 20 movably mounted on the gantry, an articulated arm 22 mounted on the slide for performing a machining operation, and a first workstation, generally designated 120, having a workpiece feeder 14′ for moving a first workpiece 16 through the gantry 18′. The system 10′ also may include a second workstation, generally designated 122, adjacent the gantry 18′, for supporting a second workpiece 124. A computer control 28′ may be connected to actuate the slide 20, the articulated arm 22, and the workpiece feeder 14′ in a coordinated manner to perform a first selected machining operation on the first workpiece 16 at the first workstation 120, and a second preselected machining operation on the second workpiece 124 at the second workstation 122. In an embodiment, the second preselected machining operation may be different from the first preselected machining operation. Also in an embodiment, the gantry 18′ may include a linear rail 30′. The slide 20 may be movably mounted on the linear rail 30′, and the workpiece feeder 14′ may be mounted on the gantry 18′ below the linear rail 30′.

In an embodiment, the second workstation 122 may be positioned adjacent the first workstation 120 along the linear rail 30′. The second workstation 122 may include a first workpiece holder, which may take the form of a first worktable 126 positioned adjacent the linear rail 30′, or in other embodiments, below or beneath the linear rail. As shown in the figures, in an embodiment, the second workstation 122 may include a second workpiece holder, which may take the form of a second worktable 128 adjacent the linear rail 30′. The first and second workpiece holders of the second workstation 122 also may include instead, or in addition to the first and second worktables 126, 128, respectively, a jig, a fixture, a clamp, or other comparable device, or a combination of such devices. The second worktable 128 may be positioned on a side of the linear rail 30′ opposite the first worktable 126, so that the worktables are on both sides of the linear rail. The slide 20 may include an energy chain 88′, which may supply power to the motors that displace the slide 20, power the swivel 24 (see FIG. 1) and actuate the articulated robot arm 22, that is sufficiently long to enable the slide to move along the linear rail 30′ to a position directly above the first workstation 120, as shown in FIG. 7. In such a position, the slide 20 may lie on a vertical line that intersects the workpiece 16, for example, at a midpoint thereof, and is perpendicular to a longitudinal centerline of the linear rail 30′.

The energy chain 88′ also may be sufficiently long to enable the slide 20 to move along the linear rail 30′ to the second workstation 122, as shown in FIG. 8. In that position, the slide 20 and articulated arm 22 may be positioned on the linear rail 30′ between the first worktable 126 and second worktable 128. In an embodiment, the first and second workpiece holders in the form of the first worktable 126 and the second worktable 128 may be plasma cutting tables. The end effector 26 attached to the articulated arm 22 may be selected from a plasma torch, an arc welder, an abrasive grinder, an adhesive applicator, a seal dispenser, a drill, and a stylus for marking or scribing the workpiece 124. With the first and second worktables 126, 128, respectively, the robot articulated arm 22 may perform machining operations on the second workpiece 124, which is supported by the first worktable 126, and/or a third workpiece 130 that may be supported on the second worktable 128. The aspect of the gantry robot system 10 shown in FIG. 1, for example, may be modified to the aspects shown in FIGS. 7 and 8 by attaching a linear rail extension 132 to the linear rail 30 (FIG. 1) to make the linear rail 30′ in those figures. Alternatively, a continuous linear rail 30′ may be provided in place of linear rail 30.

The system 10′ may include a workpiece feeder 14′ having a clamping roller 64 that is slidably mounted on the linear rail 30′, and a driven feed roller 56 mounted on the gantry 18′, and in embodiments on the linear rail 30′ opposite the clamping roller. The workpiece feeder 14′ also may include a support member 48′, positioned between the clamping roller 64 and the driven feed roller 56, for supporting the first workpiece 16.

The gantry 18′ may include a first upright support 42′ connected to and supporting an end of the linear rail 30′, a second upright support 44′ connected to and supporting a midpoint of the linear rail, and a third upright support connected to and supporting an opposite end of the linear rail 30′ from the first upright support 42′. The first worktable 126 and the second worktable 128 may be free standing; that is, they may not be attached directly to the gantry 18′. In an embodiment, the first worktable 126, and second worktable 128 may be attached to the gantry 18′, such as by a brace 136 that may be attached to the third upright support 134. With this configuration of the gantry 18′, the first workstation 120 may be located between the first upright support 42′ and the second upright support 44′. The second workstation 122 may be located between the second upright support 44′ and the third upright support 134, or the second upright support 44′ and a remainder of the linear rail 30′ extending beyond the second upright support 44′. The workpiece feeder 14′ of the first workstation 120 may include a support member 48′ positioned between the clamping roller 64 and the driven feed roller 56 for supporting the first workpiece 16.

The method for making or assembling the gantry robot system 10′ may include initially assembling the gantry 18′ to have the linear rail 30′, and the first upright support 42′, the second upright support 44′, and the third upright support 134 connected to and supporting the linear rail. The slide 20 may be attached to the gantry 18′ so that it is movable along an upper surface of the linear rail 30′. The articulated arm 22 may be mounted on the slide 20 so that it is adapted to receive an end effector 26 for performing a machining operation. The first workstation 120, which may include the workpiece feeder 14′ for moving a workpiece 16 beneath the linear rail 30′, may be attached to the gantry 18.

The second workstation 122 is provided, which may include attaching the first worktable 126, and/or the second worktable 128 to the gantry 18′, or in embodiments positioning the first worktable and/or the second worktable on opposite sides of the linear rail extension 132. The computer control 28′ is connected to control the slide 20, the articulated arm 22, and the workpiece feeder 14′. The computer control 28′ may be programmed to actuate the slide 20, the articulated arm 22, and the workpiece feeder 14′ in a coordinated manner to perform a first selected machining operation on the first workpiece 16 at the first workstation 120, and a second preselected machining operation on the second workpiece 124 at the second workstation 122. In embodiments, the computer control 28′ may be programmed to actuate the slide 20 and robot articulated arm 22 to perform a third preselected machining operation on the third workpiece 130 on the second worktable 128.

This programming also may include programming the computer control 28′ to position the slide 20 at the first workstation 120 as the articulated arm 22 performs the first preselected machining operation, and to position the slide 20 at the second workstation 122 as the articulated arm 22 performs the second and subsequent preselected machining operation on the second workpiece 124. Again, the articulated arm 22, when the slide 20 is positioned at the second workstation 122, may be rotated by the swivel 24 to perform a third preselected machining operation on the third workpiece 130, which may be placed on the second worktable 128.

In embodiments, the system 10′ also may include a scrap collecting box 138, that may be positioned below the workpiece feeder 14′. The first workpiece 16 may take the form of a flat sheet or plate made of metal, plastic, a composite, or other material, as shown in FIG. 8, or an I-beam as shown in FIG. 7. Similarly, the second and third workpieces 124, 130, respectively, may take the form of flat sheets or plates that may be metal, plastic, composite, or other material, or also may take the form of I-beams or other metal workpieces.

The embodiment 10′ of the gantry robot system may include a linear rail 18′ that is composed of a pair of box beams 140, 142, each of which includes an external rail 34′ (only the external rail 34′ being shown in the drawing figures) that supports the slide 20 for linear movement along the linear rail 30′. Each of the box beams 140, 142 also may include an internal rail 146 (only the internal rail for box beam 140 being shown in the drawing figures) for supporting the clamping roller retainer 70′ for linear movement along the linear rail 30′. The clamping roller retainer 70′ may be displaced by cylinders 66, 68, which also may be actuated by the computer control 28′. In the embodiment shown in FIGS. 7 and 8, the cylinders 66, 68 may be retained in a housing 148 that may be attached to the first upright support 42′.

The computer control 28′ may be programmed to perform machining operations on the first workpiece 16, second workpiece 124, and third workpiece 130 in any order. For example, the computer control 28′ may actuate the slide 20 to move along the linear rail 30′ to the second workstation 122 to perform a first machining operation on either one of the workpieces 124, 130. Subsequent to the machining operation, or in an embodiment during an interruption in the first machining operation, the slide 20 may be displaced along the linear rail 30′ to the first workstation 120 to perform a subsequent machining operation on the workpiece 16.

The method of operation of the gantry robot system 10′ is as follows. The computer control 28′ actuates the cylinders 66, 68 to position the clamping roller retainer 70′ and clamping roller 64 an appropriate distance from the powered or driven roller 56 to receive workpiece 16, which may take the form of an I-beam (FIG. 7) or plate (FIG. 8). The slide 20 is actuated to move along the linear rail 30′ to the first workstation 120, which may be a position above the workpiece 16, and the computer control 28′ initiates a preselected machining operation by the articulated arm 22 and end effector 26.

During this first machining operation, or prior to it, one or both workpieces 124, 130 are placed on their respective worktables 126, 128 at the second workstation 122. When the machining operation is completed at the first workstation 120, the computer control actuates the slide 20 to move along the linear rail 30′ to the second workstation 122. There, the articulated arm 22 and end effector 26 are actuated by the computer control 28′ to perform second and/or third machining operations on second and third workpieces 124 and/or 130. While this occurs, the finished, machined workpiece 16 is removed from the workpiece feeder 14′ of the first workstation 120 and replaced with an unfinished workpiece 16. When the system 10′ completes the second and/or third machining operations on workpieces 124 and/or 130, the slide 20 may return to the first workstation to begin machining the fresh workpiece 16. As described previously, the order of operation may be reversed, in which a machining operation may be performed first at the second workstation 122, on either workpiece 124 and/or 130, then a machining operation may be performed at the first workstation 120 on workpiece 16.

The system 10′ allows for a continuous operation of the articulated arm 22 and end effector 26 where the workpieces 124, 130 may be off-loaded and replaced after machining at the second workstation 122, while the articulated arm 22 and end effector 26 are performing a machining operation on the workpiece 16 at the first workstation 120. Conversely, the completed machined workpiece 16 at the first workstation 120 may be off-loaded from the gantry 18′ and a fresh workpiece 16 replaced as the articulated arm 22 and end effector 26 are performing machining operations on the second workpiece 124 and/or third workpiece 130 at the second workstation 122. This process allows the gantry robot system 10′ to actively perform preselected machining operations substantially continuously.

Although not shown in the figures, it is also within the scope of the disclosed robot gantry system 10′ to provide additional workpiece holders, some of which may take the form of worktables, at the second workstation 122, such as, for example, adjacent the end of the linear rail 30′. Further, the linear rail 30′ may be extended further than shown in the drawings, to provide a third workstation similar in design and function to the second workstation 122 shown in the figures. The resulting system provides a highly efficient and compact machining station that is capable of handling a number of different machining operations on a substantially continuous basis.

While the forms of apparatus and methods described herein constitute preferred embodiments of the disclosed gantry robot system, it is to be understood that the disclosure is not limited to these precise apparatus and methods, and that modifications may be made therein without departing from the scope of the invention as defined in the claims.

What is claimed is:

1. A gantry robot system, comprising:
a gantry;
a slide movably mounted on the gantry;
an articulated arm mounted on the slide for performing a machining operation;
a first workstation having a workpiece feeder for moving a first workpiece through the gantry;
a second workstation adjacent the gantry for supporting a second workpiece; and
a computer control connected to actuate the slide, the articulated arm, and the workpiece feeder in a coordinated manner to perform a first preselected machining operation on the first workpiece at the first workstation, and a second preselected machining operation on the second workpiece at the second workstation.

2. The gantry robot system of claim 1, wherein the second preselected machining operation is different from the first preselected machining operation.

3. The gantry robot system of claim 1, wherein the gantry includes a linear rail; the slide is movably mounted on the linear rail; and the workpiece feeder is mounted on the gantry below the linear rail.

4. The gantry robot system of claim 3, wherein the second work station is adjacent the first workstation.

5. The gantry robot system of claim 4, wherein the second workstation includes a first work table adjacent the linear rail.

6. The gantry robot system of claim 5, wherein the second work station includes a second work table adjacent the linear rail.

7. The gantry robot system of claim 6, wherein the second work table is positioned on a side of the linear rail opposite the first work table.

8. The gantry robot system of claim 7, wherein the slide is movable along the linear rail to a position directly above the first workstation.

9. The gantry robot system of claim 8, wherein the slide is movable along the linear rail to the second work station.

10. The gantry robot system of claim 9, wherein the slide is movable along the linear rail to a position between the first work table and the second work table.

11. The gantry robot system of claim 10, wherein the first work table and the second work table are plasma cutting tables.

12. The gantry robot system of claim 10, wherein the articulated arm terminates in an end effector selected from a plasma torch, an arc welder, an abrasive grinder, an adhesive applicator, a seal dispenser, a drill, and a stylus for marking or scribing.

13. The gantry robot system of claim 10, wherein the workpiece feeder includes a clamping roller slidably mounted on the linear rail; and a driven feed roller mounted on the gantry opposite the clamping roller.

14. The gantry robot system of claim 13, wherein the workpiece feeder includes a support member, positioned between the clamping roller and the driven feed roller, for supporting the first workpiece.

15. The gantry robot system of claim 14, wherein the gantry includes a first upright support connected to and supporting an end of the linear rail; a second upright support connected to and supporting a midpoint of the linear rail; and a third upright support connected to and supporting an opposite end of the linear rail.

16. The gantry robot system of claim 15, wherein the first workstation is located between the first upright support and the second upright support; and the second workstation is located between the second upright support and the third upright support.

17. The gantry robot system of claim 16, wherein the workpiece feeder of the first workstation includes a support member positioned between the clamping roller and the driven feed roller for receiving and supporting the first workpiece.

18. A gantry robot system, comprising:
a gantry having a linear rail;
a first workstation having a workpiece feeder for moving a first workpiece beneath the linear rail;
a second workstation adjacent the linear rail having a first worktable for supporting a second workpiece, and a second worktable for supporting a third workpiece, the linear rail extending between the first work table and the second worktable;
a slide mounted on the linear rail and movable to the first workstation and to the second workstation;
an articulated arm mounted on the slide for performing a machining operation; and
a computer control connected to actuate the slide, the articulated arm, and the workpiece feeder in a coordinated manner to perform a first preselected machining operation on the first workpiece at the first workstation, a second preselected machining operation on the second workpiece at the second workstation, and a third preselected machining operation on the third workpiece at the second workstation.

19. A method for making a gantry robot system, the method comprising:
assembling a gantry having a linear rail, and first, second, and third upright supports connected to and supporting the linear rail;
attaching a slide to the gantry that is movable along the linear rail;
mounting an articulated arm on the slide that is adapted to receive an end effector for performing a machining operation;
attaching a first workstation to the gantry, the first workstation having a workpiece feeder for moving a first workpiece beneath the linear rail;
providing a second workstation adjacent a portion of the linear rail extending beyond the first workstation, the second workstation including a work table for supporting a second workpiece shaped to be positioned adjacent the linear rail; and
connecting a computer control to the slide, the articulated arm, and the workpiece feeder, and programming the computer control to actuate the slide, and the articulated arm, and the workpiece feeder in a coordinated manner to perform a first preselected machining operation on the first workpiece at the first workstation, and a second preselected machining operation on the second workpiece at the second workstation.

20. The method of claim 19, wherein programming the computer includes programming the computer to position the slide at the first workstation as the articulated arm performs the first preselected machining operation, and to position the slide at the second workstation as the articulated arm performs the second preselected machining operation.
